(19) United States
(12) Patent Application Publication
(10) Pub. No.: US 2025/0383792 A1
(43) Pub. Date: Dec. 18, 2025

(54) POWER MANAGEMENT WITH DYNAMIC DATA TRANSFER SPEED ADJUSTMENT

(71) Applicant: Micron Technology, Inc., San Jose, CA (US)

(72) Inventors: Yu-Chung Lien, San Jose, CA (US); Zhenming Zhou, San Jose, CA (US)

(21) Appl. No.: 19/238,925

(22) Filed: Jun. 16, 2025

Related U.S. Application Data
(60) Provisional application No. 63/660,850, filed on Jun. 17, 2024.

(51) Int. Cl. G06F 3/06

(52) U.S. Cl. CPC G06F 3/0625; G06F 3/0659; G06F 3/0679

(57) ABSTRACT

A processing device monitors power consumption of a memory device that is communicatively coupled with the processing device via a data transfer interface. The data transfer interface comprises a plurality of channels. The processing device dynamically adjusts a data transfer speed of at least one channel of the plurality of channels of the interface based on the monitored power consumption of the memory device and a power budget. The power budget comprises an amount of power consumption allowed for the memory device.

### PRIORITY APPLICATION

This application claims the benefit of priority to U.S. Provisional Application Ser. No. 63/660,850, filed Jun. 17, 2024, which is incorporated herein by reference in its entirety.

### TECHNICAL FIELD

Embodiments of the disclosure relate generally to memory sub-systems and, more specifically, to power management in a memory sub-system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some embodiments of the present disclosure.

FIGS. 2A and 2B are conceptual diagrams illustrating a technique for managing power consumption of a memory sub-system, in accordance with some embodiments of the present disclosure.

FIGS. 3 and 4 are flow diagrams illustrating example methods for managing power consumption of a memory sub-system, in accordance with some embodiments of the present disclosure.

FIG. 5 is a block diagram of an example computer system in which embodiments of the present disclosure may operate.

### DETAILED DESCRIPTION

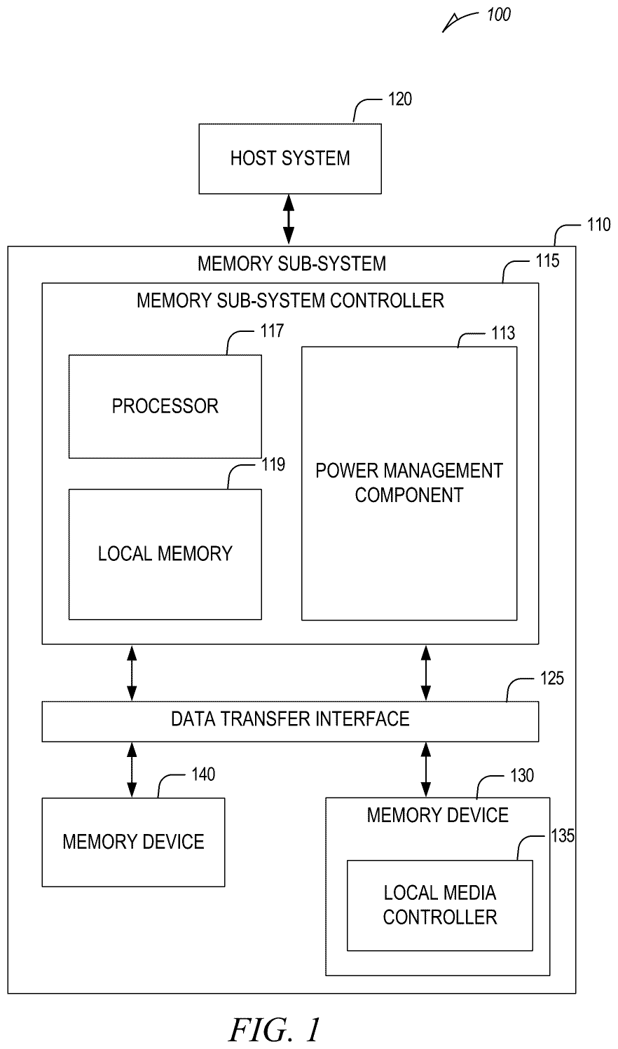

Aspects of the present disclosure are directed to an approach for power management in a memory sub-system. A memory sub-system can comprise a memory device (e.g., SSD), a memory module, or a combination of a memory device and memory module. Examples of memory devices and memory modules are described below in conjunction with FIG. 1.

A memory device can be a non-volatile memory device. One example of a non-volatile memory device is a negative-and (NAND) memory device. In general, a host system can utilize a memory sub-system that includes one or more components, such as memory devices that store data. For example, the host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

As the demand for higher performance and larger storage capacities increases, managing the power consumption of memory devices has become an important aspect of their design and operation. The current state of the art in power management of memory devices such as NAND memory devices involves predictive peak power management (pPPM) systems. These systems are designed to prevent the power consumption of the device from exceeding a predetermined power budget. The power budget ensures the stability and reliability of the memory device while also complying with the power supply limitations of the host device.

In typical pPPM systems, all NAND dies within a memory device share a token ring that represents the power credit available to them. The power credit (also referred to as “power token”) is consumed based on the power usage of each NAND die, and when the credit is depleted, the pPPM system either slows down the operation of individual NAND dies or postpones planned operations. This approach is intended to reduce peak power consumption and distribute power usage more evenly over time.

An Open NAND Flash Interface (ONFI) is a standardized interface that facilitates data transfers between the NAND memory devices and the memory sub-system controller. The ONFI speed, which dictates the rate at which data is transferred, is a significant factor in the overall performance of the memory device. For example, higher ONFI speeds can lead to shorter data transfer times, but they also increase power consumption, contributing to the challenge of peak power management.

Conventional pPPM systems attempt to balance the trade-off between performance and peak power consumption in memory devices. However, they often face limitations when it comes to flexibility and adaptability. For example, the static nature of the power management strategies may not account for the dynamic variations in power usage that occur during different NAND operations, such as program, read, and erase cycles. Additionally, the power management system must be robust enough to handle various bit per cell (BPC) technologies, such as single-level cell (SLC), multi-level cell (MLC), triple-level cell (TLC), quad-level cell (QLC), and penta-level cell (PLC), each with its own power and performance characteristics.

Aspects of the present disclosure address the above and other issues in power management by dynamically adjusting data transfer speeds of a data transfer interface (such as an ONFI) based on a real-time power consumption (e.g., instantaneous power consumption) of the memory device and a power budget allocated to the device. In an example, a power management component of a memory sub-system monitors real-time power consumption of a memory device and performs a comparison of the real-time power consumption with a threshold that is based on the power budget. Based on the comparison, the power management component dynamically adjusts a data transfer speed of one or more channels of a data transfer interface used by the memory device to communicate (e.g., transfer and receive data) with the memory sub-system controller. In a more detailed example, the power management component decreases a speed of a channel of the data transfer interface, thereby reducing power consumed by a corresponding die that is communicatively coupled with the memory sub-system via the channel of the interface.

Dynamically adjusting data transfer speeds based on real-time power consumption of the device allows for more operations to be performed in the same time duration without exceeding the power budget. This dynamic adjustment significantly improves system performance, particularly for large-capacity drives, by enhancing the parallelism of data transfer and reducing instances in which operations are slowed down or postponed due to power budget constraints.

While the power management techniques for dynamically adjusting data transfer speeds of data transfer interface may find particular application in NAND-based memory sub-systems in which a NAND device communicates with a memory sub-system controller via an ONFI, it shall be appreciated that these techniques are not limited to NAND-based memory sub-systems and may also be applicable to other types of non-volatile memory devices such as resistive random-access memory (ReRAM) or Phase-Change Memory (PCM) that utilize other types of data transfer interfaces.

FIG. 1 illustrates an example computing environment 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a USB interface, a Fibre Channel interface, a Serial Attached SCSI (SAS) interface, and so forth. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface provides a physical link with multiple communication lanes (also referred to herein simply as “lanes”) for passing control, address, data, and other signals between the memory sub-system 110 and the host system 120.

The memory devices can include any combination of the different types of non-volatile memory devices 130 and/or volatile memory devices 140. The volatile memory devices 140 can be, but are not limited to, random access memory (RAM), such as dynamic random access memory (DRAM) and synchronous dynamic random access memory (SDRAM).

The non-volatile memory devices 130 can be, but are not limited to, NAND type flash memory that include one or more arrays of memory cells such as SLCs, multi-level cells (MLCs) (e.g., TLCs, or quad-level cells [QLCs]). Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

A memory sub-system controller 115 can communicate with the memory devices 130 and 140 to perform operations such as reading data, writing data, or erasing data at the memory devices 130 and 140 and other such operations. For example, the memory sub-system controller 115 can be coupled to any one or more of the memory device 130 or 140 over a data transfer interface 125. The data transfer interface 125 comprises multiple channels to facilitate communication between the memory sub-system controller 115 and the memory devices 130 and 140. In an example, the memory device 130 includes multiple dies and each die of the memory device 130 uses one of the channels to communicate with the memory sub-system controller 115. That is, a given die of the memory device 130 may communicate (e.g., send and receive data and commands) with the memory sub-system controller 115 over a channel of the data transfer interface 125 dedicated to the die. In an example, the data transfer interface 125 is an Open Nand Flash Interface (ONFI).

The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a power management component 113 that is responsible for managing power consumption of the memory devices 130 and 140. The power management component 113 may utilize multiple techniques for managing power consumption of the memory devices 130 and 140. As an example, the power management component 113 may monitor real-time power consumption of the memory device 130 and dynamically adjust data transfer speeds of channels of the data transfer interface 125 based on the real-time power consumption and a power budget associated with the memory device 130. For example, the power budget may be divided into multiple portions (also referred to herein as “power tokens”), and the portions of the power budget are allocated across the multiple dies of the memory device 130 by the power management component 113. Consistent with these examples, the power management component 113 may increase the data transfer speed of a channel of the data transfer interface 125 based on determining the power consumed by the corresponding die of the memory device 130 is below the portion of the power budget allocated to the die. Further, the power management component 113 may decrease the data transfer speed of a channel of the data transfer interface 125 based on determining the power consumed by the corresponding die of the memory device 130 is above the portion of the power budget allocated to the die.

In some embodiments, the memory sub-system controller 115 includes at least a portion of the power management component 113. For example, the memory sub-system controller 115 can include a processor 117 (processing device) configured to execute instructions stored in local memory 119 (e.g., firmware) for performing the operations described herein. In some embodiments, the power management component 113 is part of the host system 120, an application, or an operating system. Further details regarding the power management component 113 are discussed below.

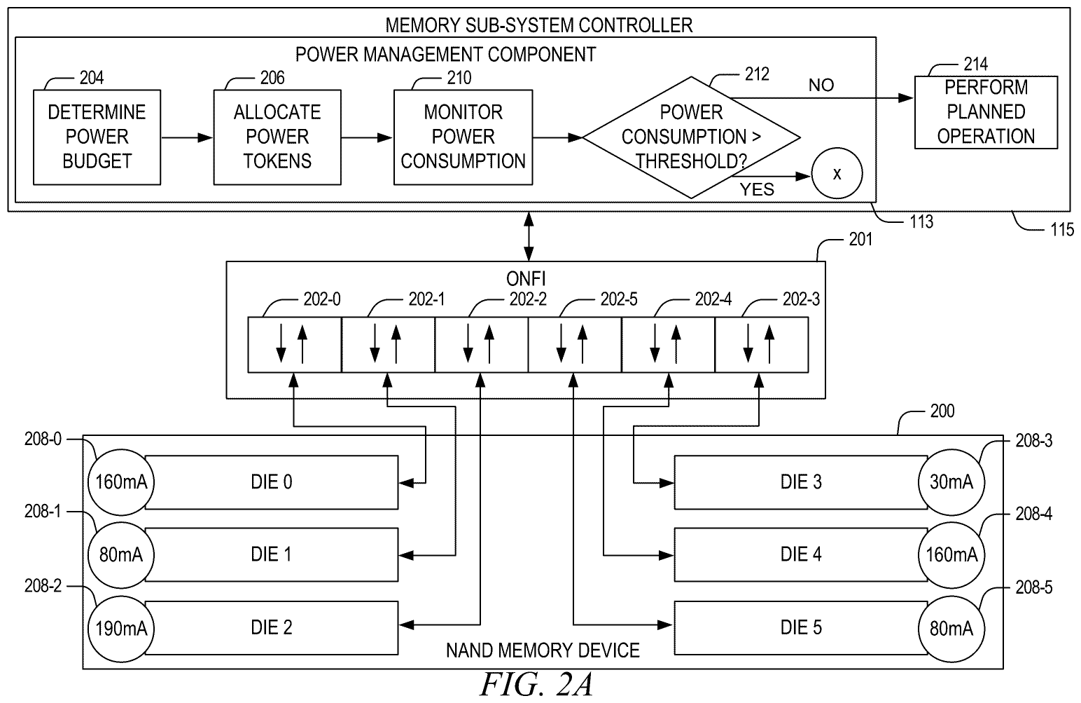

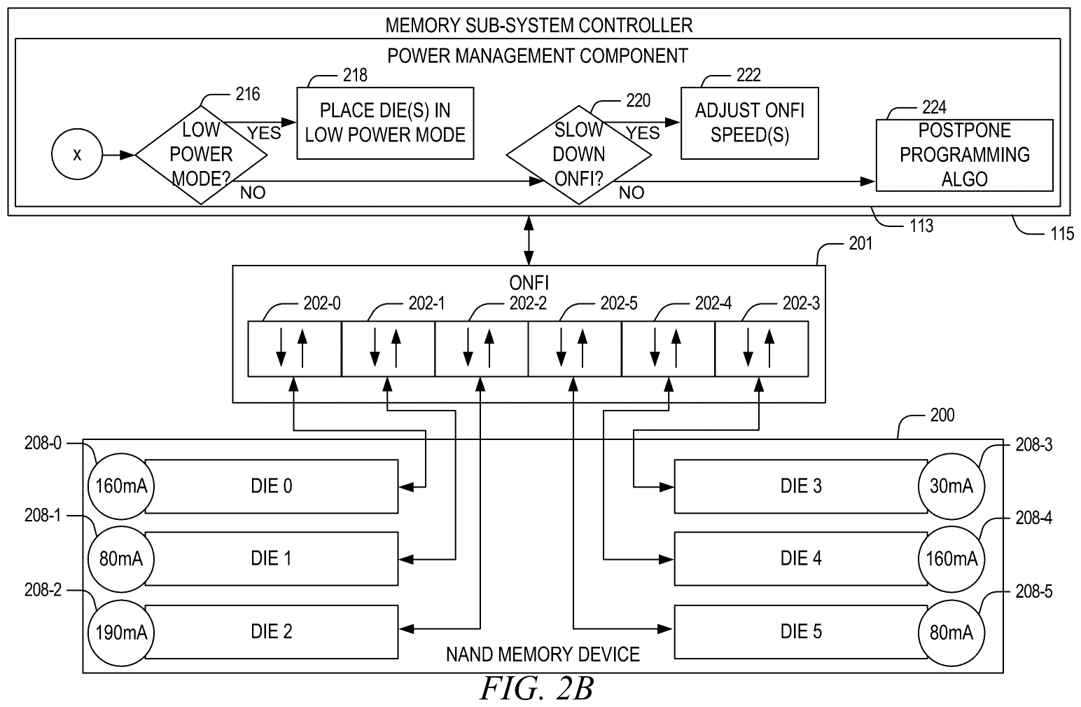

FIGS. 2A and 2B are conceptual diagrams illustrating a technique for managing power consumption of a NAND memory device 200, in accordance with some embodiments of the present disclosure. In the example illustrated in FIGS. 2A and 2B, the NAND memory device 200 is an example memory device 130.

As shown, the NAND memory device 200 includes multiple NAND dies—die 0, die 1, die 2, die 3, die 4, and die 5. Each die may include one or more planes and each plane includes multiple blocks. Each block includes a two- or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the Vt of the transistor. SLC NAND, for example, can store one bit per cell. Other types of memory cells, such as MLCs, TLCs, QLCs, and penta-level cells (PLCs), can store multiple bits per cell.

In the example shown in FIGS. 2A and 2B, the memory sub-system controller 115 is coupled to the NAND memory device via an ONFI 201, which is an example of the data transfer interface 125. The ONFI 201 comprises multiple channels to facilitate communication between the memory sub-system controller 115 and the NAND memory device 200. For example, as shown, the ONFI 201 comprises channels 202-0 to 202-5. Each die of the memory device 200 is communicatively coupled to the memory sub-system 115 via a channel of the ONFI 201. That is, each die uses a channel of the ONFI 201 to communicate (e.g., transfer and receive data) with the memory sub-system controller 115. For example, as shown, die 0 is communicatively coupled to the controller 115 via channel 202-0; die 1 is communicatively coupled to the controller 115 via channel 202-1; die 2 is communicatively coupled to the controller 115 via channel 202-2; die 3 is communicatively coupled to the controller 115 via channel 202-3; die 4 is communicatively coupled to the controller 115 via channel 202-4; and die 5 is communicatively coupled to the controller 115 via channel 202-5.

With reference to FIG. 2A, at operation 204, the power management component 113 determines a power budget for the memory device 130. The power budget defines an amount of power (e.g., instantaneous power) that the memory device 130 is allowed to consume. In some examples, the power budget comprises a predetermined number (corresponding to the amount of power the memory device is allowed to consume) and the power management component 113 determines the power budget by accessing the predetermined number from a register or an in-memory data structure. Consistent with some examples, the power budget includes an amount of current (i.e., measured in amperes) from which the amount of power the memory device 200 is allowed to consume may be determined or derived.

The power budget for the memory device 200 may be determined based on several factors that ensure that the memory device 200 operates efficiently without exceeding its capabilities. In some examples, the power budget may be based on any one or more of: device specifications and requirements (e.g., maximum power supply capacity, thermal limits, and power requirements of other components in the device 130); NAND die characteristics; system-level considerations (e.g., power used for data transfer interfaces such as ONFI, error correction and other management tasks performed by the memory sub-system controller 115 and/or local controller 135); performance and efficiency goals; safety and reliability margins; real-world testing and modeling; and standards and regulatory requirements. In the example illustrated in FIGS. 2A and 2B, the power budget for the memory device 130 is 700 mA.

The power management component 113 divides the power budget into multiple power tokens and allocates the power tokens among the dies of the memory device 200, at operation 206. Power tokens are used to regulate and balance power usage across various operations and components, ensuring that no single part exceeds its allocated share of the total power budget. Each power token corresponds to a portion of the power management budget. Consistent with examples in which the power budget includes a measure of current, the portion of the power budget corresponding to each power token comprises an amount of current (e.g., expressed in amperes). Each die of the memory device is allocated one or more power tokens. For example, as shown, the power management component 113 allocates: a first power token (208-0) corresponding to 160 mA to die 0; a second power token (208-1) corresponding to 80 mA to die 1; a third power token (208-2) corresponding to 190 mA to die 2; a fourth power token (208-3) corresponding to 30 mA to die 3; a fifth power token (208-4) corresponding to 160 mA to die 4; and a sixth power token (208-5) corresponding to 80 mA to die 5.

In some examples, in addition to allocating power tokens among the dies, the dies of the memory device 200 are configured to share a token ring, which is a communication and management protocol used to monitor and control the distribution and usage among the NAND dies. The power token ring operates as a dynamic regulatory system that ensures each die adheres to its power token allocation. The token ring facilitates the real-time tracking and reallocation of power tokens based on current power consumption, allowing for adjustments in power allocation to optimize overall performance and efficiency of the memory device 130.

At operation 210, the power management component 113 monitors the power consumption (e.g., instantaneous power consumption) of each die of the memory device 200 to determine when to perform power consumption management operations on the memory device 200. Based on the monitored power consumption, the power management component 113 may perform one or more power management operations prior to or during the execution of a planned operation to be performed in response to a command from the memory sub-system controller 115 such as a read, write, or erase command. These power consumption management operations include, but are not limited to, placing a die of the memory device 200 in low power mode, adjusting (e.g., decreasing) a data transfer speed of the ONFI 201, and postponing a NAND programming operation.

For example, as shown, the power management component 113 determines whether the instantaneous power consumption of the memory device 200 exceeds a power consumption threshold for the memory device, at operation 212. The power consumption threshold is based on the power budget. If the power management component 113 determines the instantaneous power consumption of the memory device 200 does not exceed the power consumption threshold of the memory device 200, the power management component 113 allows execution of the planned operation without performing any power consumption management operations, at operation 214.

With reference to FIG. 2B, if the power management component 113 determines the instantaneous power consumption exceeds the power consumption threshold (e.g., the power budget), the power management component 113, at operation 216, determines whether operating at least one die of the memory device 200 in low power mode would bring the power consumption of the memory device 200 within the power budget. If so, the power management component 113 places at least one die of the memory device 130 in low power mode prior to or during execution of the planned operation, at operation 218.

If not, the power management component 113 determines whether adjusting (e.g., decreasing) a data transfer speed of at least one channel of the ONFI 201 would bring the power consumption of the memory device 130 under the power consumption threshold, at operation 220. If so, the power management component 113 adjusts (e.g., decreases) the data transfer speed of at least one channel of the ONFI 201 prior to or during execution of the planned operation, at operation 222. In some examples, in adjusting the data transfer speed, the power management component 113 accesses a look-up table comprising a mapping between data transfer speeds and power consumption levels to determine an appropriate data transfer speed.

If not, the power management component 113 postpones performance of the planned operation and the process of operations, at operation 224.

In some examples, the comparison of the power consumption of the memory device 200 to the power consumption threshold, as addressed above in relation to operations 210, 212, 214, 216, 218, and 220 includes comparing a total instantaneous power consumption of the memory device 200 to the total power budget. In these examples, the power consumption threshold is the power budget. In other examples, the operations 210, 212, 214, 216, 218, and 220 include a comparison of an amount of power consumption by a given die with the portion of the power budget allocated to the die (as reflected by the power token allocated to the die). That is, in these examples, the power consumption threshold corresponds to the portion of the power budget allocated to the die (as reflected by the power token allocated to the die). Consistent with these other examples, the power management component 113 determines, at operation 210, whether the instantaneous power consumption of a die of the memory device 200 exceeds the portion of the power budget allocated to die (e.g., based on the power token allocated to the die). If the power management component 113 determines the instantaneous power consumption of the die does not exceed the portion of the power budget allocated to the die, the power management component 113 allows execution of the planned operation without performing any power consumption management operations (at operation 212). If the power management component 113 determines the instantaneous power consumption of the die exceeds the portion of the power budget allocated to the device, the power management component 113 (at operation 214), determines whether operating the die in low power mode would bring the power consumption of the die within the portion of the power budget allocated to the die. If so, the power management component 113 places the die in low power mode during execution of the planned operation, at operation 216. If not, the power management component 113 determines whether adjusting (e.g., decreasing) a data transfer speed of a channel of the ONFI 201 used by the die would bring the power consumption of the die within the portion of the power budget allocated to the die (at operation 218). If so, the power management component 113 adjusts (e.g., decreases) the data transfer speed of the channel of the ONFI 201 prior to or during execution of the planned operation (at operation 220).

In addition, as noted above, in some examples, the dies of the memory device 200 may be configured in a token ring, which, among other things, facilitates reallocation of the power tokens based on the power consumption of the memory device 200. Consistent with these examples, the power management component 113 may reallocate a first power token from a first die to a second die and may reallocate a second power token from a third die to the first die based on monitoring the power consumption (e.g., instantaneous power consumption). Upon performing this reallocation, the power management component 113 may repeat the operations 210, 212, 214, 216, 218, and 220 in accordance with the reallocation of power tokens. Hence, the power management component 113 can, in some examples, adjust a data transfer speed of a channel of the ONFI 201 corresponding to the first die in response to the reallocation of the first and second power tokens.

In general, the power management component 113 operates in a feedback loop where the monitored power consumption of the memory device 200 informs the decisions of the power management component 113 in adjusting data transfer speeds of the ONFI 201. This feedback loop ensures that the power management component 113 can adaptively manage power consumption of the memory device 200 during intensive operations like data transfers while maintaining stability and efficiency.

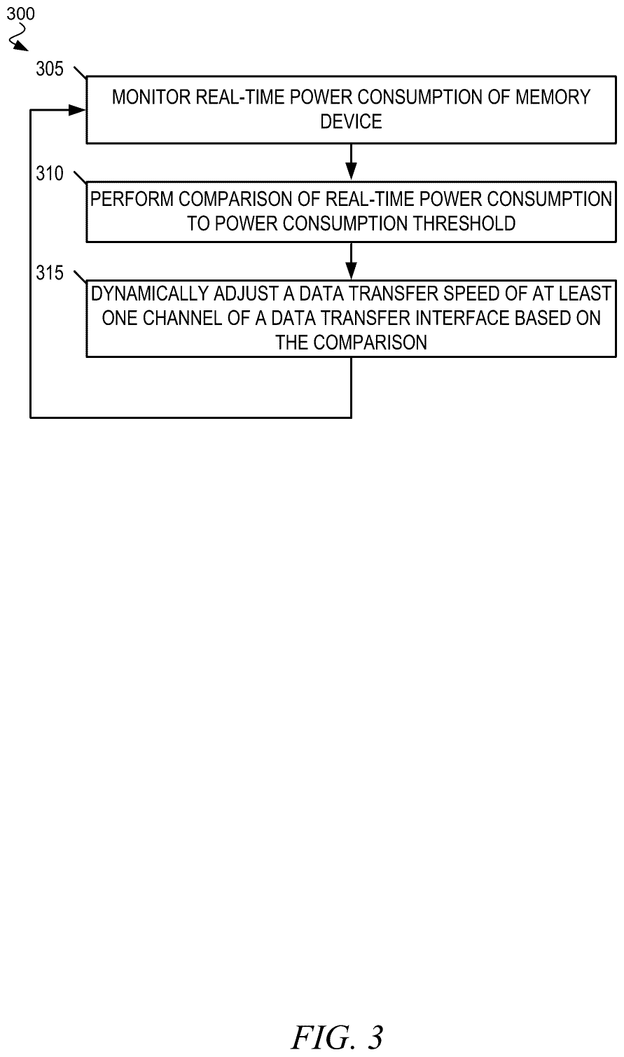

FIG. 3 is a flow diagram illustrating an example method 300 for managing power consumption of a memory sub-system, in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the power management component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Examples of the operation of the method 300 are provided below along with the description of the method 300. In the context of these examples, a memory sub-system comprises a memory device, and the memory device comprises multiple dies-a first die, a second die, a third die, and a fourth die. Additionally, in these examples, the memory device is communicatively coupled to a memory sub-system controller (e.g., comprising or corresponding to a processing device) via a memory device interface and the memory device interface comprises multiple channels-a first channel, a second channel, a third channel and a fourth channel. Consistent with these examples, the first die of the memory device is communicatively coupled with the memory sub-system controller via a first channel of the memory device interface; the second die of the memory device is communicatively coupled with the memory sub-system controller via a second channel of the memory device interface; the third die of the memory device is communicatively coupled with the memory sub-system controller via a third channel of the memory device interface; and the fourth die of the memory device is communicatively coupled with the memory sub-system controller via a fourth channel of the memory device interface.

At operation 305, a processing device monitors real-time power consumption of the memory device (e.g., instantaneous power consumption). In monitoring the power consumption of the memory device, the processing device monitors power consumption of each die of the memory device. For example, in monitoring the power consumption of the memory device, the processing device determines a first amount of power consumed for die 1, a second amount of power consumed for die 2, a third amount of power consumed for die 3 and a fourth amount of power consumed for die 4. In an example, determining an amount of power consumed by a given die of the memory device can include determining an amount of instantaneous power consumption by the die.

At operation 310, the processing device performs a comparison of the real-time power consumption of the memory device with a power consumption threshold for the memory device. The power consumption threshold is based on a predetermined power budget associated with the memory device. The predetermined power budget comprises an amount of power (e.g., instantaneous power) the memory device is allowed to consume.

As discussed above, the processing device may divide the power budget into multiple power tokens, each representing a portion of the power budget, and the processing device allocates the multiple power tokens among the multiple dies of the memory device. In an example, the processing device divides the power budget into four power tokens-a first power token representing a first portion of the power budget; a second power token representing a second portion of the power budget; a third power token representing a third portion of the power budget; and a fourth power token representing a fourth portion of the power budget. Consistent with this example, the processing device allocates: the first power token to the first die of the memory device; the second power token to the second die of the memory device; the third power token to the third die of the memory device; and the fourth power token to the fourth die of the memory device.

At operation 315, the processing device dynamically adjusts a data transfer speed of at least one channel of the interface based on the real-time power consumption of the memory device and the power budget of the memory device. In a first example, the processing device dynamically adjusts a data transfer speed of at least one channel of the interface based on a comparison of the total power consumption of the memory device to the power budget of the memory device. That is, the processing device may decrease the data transfer speed of at least one channel of the memory device interface based on determining the total power consumption of the memory device (e.g., the total instantaneous power consumption of the memory device) is above the power budget. Consistent with the first example, the processing device may increase the data transfer speed of at least one channel of the memory device interface based on determining the total power consumption of the memory device (e.g., the total instantaneous power consumption of the memory device) is below the power budget.

In a second example, the processing device adjusts the data transfer speed of a given channel based on a comparison of the instantaneous power consumption of a corresponding die (e.g., the die that uses the channel to communicate with the memory sub-system controller) with a portion of the power budget allocated to the die (corresponding to the power token allocated to the die). That is, the processing device may decrease a data transfer speed of a channel (e.g., the first channel) based on determining the power consumption of a corresponding die (e.g., the first die) is above the portion of the power budget allocated to the die (e.g., the first power token). In other words, the processing device decreases the data transfer speed of the channel based on the power consumption corresponding to the die being greater than the portion of the power budget allocated to the die. In another example, the processing device increases a data transfer speed of a channel (e.g., the second channel) based on determining the power consumption of a corresponding die (e.g., the second die) is below the portion of the power budget allocated to the die (e.g., the second power token). In other words, the processing device increases the data transfer speed of the channel based on the power consumption corresponding to the die being less than the portion of the power budget allocated to the die.

The processing device can adjust a data transfer speed prior to or during a data transfer being performed in response to a read command, a write command, or an erase command, or any other type of data transfer.

In adjusting the transfer speed of a given channel of the interface, the processing device may access and consult a look-up table comprising a mapping between data transfer speeds and power consumption levels to determine a target data transfer speed for the channel to bring the power consumption of the corresponding die within the portion of the power budget allocated to the die.

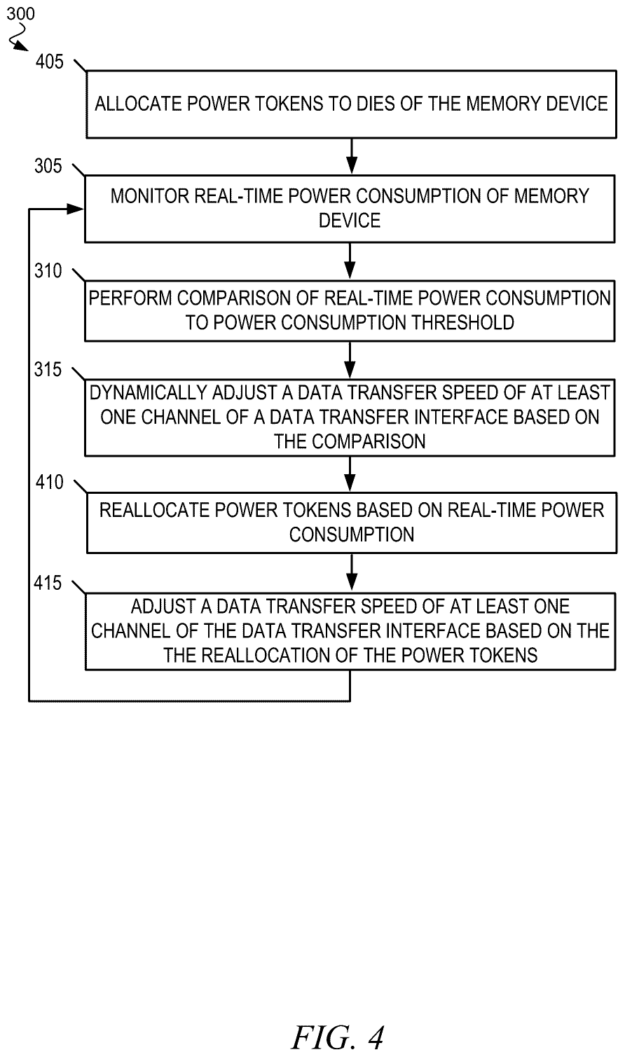

As shown in FIG. 4, the method 300 may, in some examples, include operations 405, 410, and 415. Consistent with these examples, the operation 405 may be performed prior to operation 305 where the processing device monitors power consumption (e.g., instantaneous power consumption) of the memory device. At operation 405, the processing device allocates power tokens to the dies of the memory device. Each power token represents a portion of the power budget and each die is allocated one or more power tokens. Allocating a given power token to a given die allocates the corresponding portion of the power budget to the die.

Consistent with these examples, the operation 410 is performed subsequent to the operation 405 and can be performed prior to, as part of, or subsequent to operation 310 or operation 315. At operation 410, the processing device reallocates one or more power tokens among the dies of the memory device based on the monitoring of the power consumption of the memory device. For example, the processing device may reallocate a first power token allocated to a first die to a second die and/or the processing device may reallocate a second power token allocated to a third die to the first die.

Consistent with these examples, the operation 415 is performed subsequent to the operation 410 and can be performed as part of or subsequent to the operation 315 where the processing device dynamically adjusts data transfer speeds of one or more channels of the data transfer interface. At operation 415, the processing device adjusts a data transfer speed of one or more channels of the data transfer interface based on the reallocation of the one or more power tokens. Returning to the example of reallocation mentioned above, the reallocation of the first power token from the first die to the second die and/or the reallocation of the second power token from the third die to the first die changes the portion of the power budget allocated to the first die. The change to the portion of the power budget allocated to the first die results in the power consumption of the first die exceeding the portion of the power budget allocated to the first die, and thus, the processing device decreases a data transfer speed of the channel of the data transfer interface corresponding to the die to bring the power consumption of the die within the newly allocated portion of the power budget allocated to the die.

While the above examples specifically address the real-time power consumption of the memory device and power budget as the basis for the processing device's dynamic adjustments to data transfer speeds of the data transfer interface, it shall be appreciated that, in other examples, other factors may be utilized in dynamically adjusting data transfer speeds. That is, in other examples, factors such as the power consumption of the data transfer interface and elapsed time of the data transfer can be used as additional or alternative bases for dynamically adjusting data transfer speeds.

Described implementations of the subject matter can include one or more features, alone or in combination as illustrated below by way of example.
Example 1. A system comprising: a memory device; a data transfer interface comprising a plurality of channels; and a processing device coupled to the memory device via the data transfer interface, the processing device to perform operations comprising: monitoring power consumption of the memory device; and dynamically adjusting a data transfer speed of at least one channel of the plurality of channels of the data transfer interface based on the monitored power consumption of the memory device and a power budget allocated to the memory device, the power budget comprising an amount of power consumption allowed for the memory device.
Example 2. The memory sub-system of Example 1, wherein dynamically adjusting the data transfer speed of the at least one channel comprises decreasing the data transfer speed of the at least one channel based on determining the power consumption of the memory device is above the power budget.
Example 3. The memory sub-system of any one or more of Examples 1 or 2, wherein dynamically adjusting the data transfer speed of the at least one channel comprises increasing the data transfer speed of the at least one channel based on determining the monitored power consumption of the memory device is below the power budget.
Example 4. The memory sub-system of any one or more of Examples 1-3, wherein the operations comprise performing a comparison based on the monitored power consumption of the memory device and the power budget, wherein the dynamic adjusting of the data transfer speed of the at least one channel is based on the comparison.
Example 5. The memory sub-system of any one or more of Examples 1-4, wherein: the monitored power consumption of the memory device comprises an amount of power consumed by a die from among multiple dies of the memory device; the performing of the comparison comprises comparing the amount of power consumed by the die with a portion of the power budget allocated to the die; and the dynamic adjusting of the data transfer speed of at least one channel comprises adjusting a data transfer speed of a channel of the data transfer interface used by the die.
Example 6. The memory sub-system of any one or more of Examples 1-5, wherein the adjusting of the data transfer speed of the channel of the data transfer interface comprises one of: increasing the data transfer speed of the channel based on determining that the amount of power consumed by the die is less than the portion of the power budget allocated to the die; and decreasing the data transfer speed of the channel based on determining that the amount of power consumed by the die is greater than the portion of the power budget allocated to the die.
Example 7. The memory sub-system of any one or more of Examples 1-6, wherein dynamically adjusting the data transfer speed of the at least one channel is performed during a data transfer over the data transfer interface based on one of: a read command, a write command, or an erase command.
Example 8. The memory sub-system of any one or more of Examples 1-7, wherein dynamically adjusting the data transfer speed of the at least one channel comprises accessing a look-up table comprising a mapping between data transfer speeds and power consumption levels.
Example 9. The memory sub-system of any one or more of Examples 1-8, wherein: the memory device comprises a plurality of dies; the monitoring of power consumption of the memory device comprises determining an amount of power consumption for a first die in the plurality of dies; the operations comprise: dividing a power budget into a plurality of power tokens, each power token corresponding to a portion of the power budget; allocating the plurality of power tokens to the plurality of dies, the allocating of the plurality of power tokens comprising allocating a first power token to the first die, the first power token corresponding to a first portion of the power budget; and comparing the amount of power consumption for the first die with the first portion of the power budget corresponding to the first power token; and the dynamically adjusting of the data transfer speed of at least one channel comprises adjusting a data transfer speed of a first channel of the data transfer interface used by the first die based on a result of comparing the amount of power consumed by the first die with the first portion of the power budget corresponding to the first power token.
Example 10. The memory sub-system of any one or more of Examples 1-9, wherein the operations comprise reallocating the plurality of power tokens to the plurality of dies based on the power consumption of the memory device, the dynamically adjusting of the data transfer speed of at least one channel adjusting the data transfer speed of the first channel based on the reallocating of the plurality of power tokens to the plurality of dies.
Example 11. The memory sub-system of any one or more of Examples 1-10, wherein reallocating the plurality of power tokens to the plurality of dies comprises at least one of: reallocating the first power token from the first die to a second die; and reallocating a second power token from a third die to the first die.
Example 12. The memory sub-system of any one or more of Examples 1-11, wherein the monitored power consumption of the memory device comprises an amount of instantaneous power consumption.
Example 13. The memory sub-system of any one or more of Examples 1-12, wherein: the memory device comprises NAND memory; the data transfer interface comprises an Open NAND Flash Interface (ONFI); and the processing device comprises a memory sub-system controller.
Example 14. A method comprising: monitoring, by a processing device, power consumption of a memory device, the memory device being communicatively coupled to a memory sub-system controller via a data transfer interface, the data transfer interface comprising a plurality of channels; performing, by the processing device, a comparison based on the power consumption of the memory device and a power budget allocated to the memory device; and dynamically adjusting, by the processing device, a data transfer speed of at least one channel of the plurality of channels of the data transfer interface based on the monitored power consumption of the memory device and a power budget, the power budget comprising an amount of power consumption allowed for the memory device.
Example 15. The method of Example 14, wherein: the monitored power consumption of the memory device comprises an amount of power consumed by a die from among multiple dies of the memory device; the performing of the comparison comprises comparing the amount of power consumed by the die with a portion of the power budget allocated to the die; and the dynamic adjusting of the data transfer speed of at least one channel comprises adjusting the data transfer speed of a channel of the data transfer interface used by the die.
Example 16. The method of any one or more of Examples 14 or 15, wherein the adjusting of the data transfer speed of the channel of the data transfer interface comprises decreasing the data transfer speed of the channel based on determining that the amount of power consumed by the die is greater than the portion of the power budget allocated to the die.
Example 17. The method of any one or more of Examples 14-16, wherein dynamically adjusting the data transfer speed of the at least one channel comprises adjusting the data transfer speed of a channel of the data transfer interface during a data transfer over the data transfer interface based on one of: a read command, a write command, or an erase command.
Example 18. The method of any one or more of Examples 14-17, wherein dynamically adjusting the data transfer speed of the at least one channel comprises accessing a look-up table comprising a mapping between data transfer speeds and power consumption levels.
Example 19. The method of any one or more of Examples 14-18, wherein: the memory device comprises NAND memory; the data transfer interface comprises an Open NAND Flash Interface (ONFI); and the memory sub-system controller comprises the processing device.
Example 20. A computer-readable storage medium comprising instructions that, when executed by a processing device, configure the processing device to perform operations comprising: monitoring power consumption of a memory device, the memory device being communicatively coupled to a memory sub-system controller via a data transfer interface, the data transfer interface comprising a plurality of channels; performing a comparison based on the power consumption of the memory device and a power budget allocated to the memory device; and dynamically adjusting a data transfer speed of at least one channel of the plurality of channels of the data transfer interface based on the monitored power consumption of the memory device and a power budget, the power budget comprising an amount of power consumption allowed for the memory device.

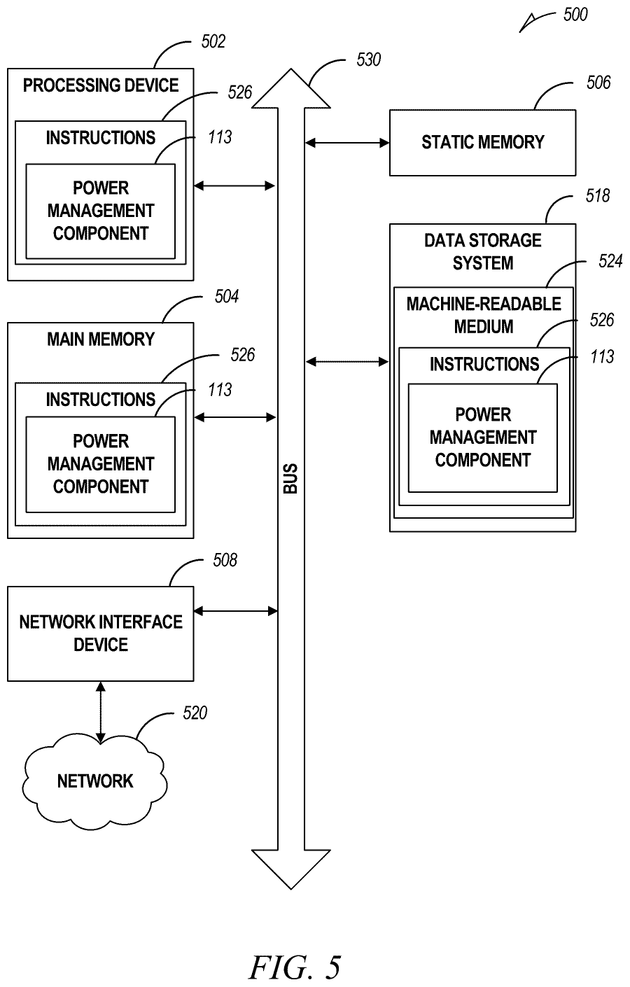

FIG. 5 illustrates an example machine in the form of a computer system within which a set of instructions can be executed for causing the machine to perform any one or more of the methodologies discussed herein. FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the power management component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an ASIC, a FPGA, a digital signal processor (DSP), network processor, or the like. The processing device 502 is configured to execute instructions 526 for performing the operations and steps discussed herein. The computer system 500 can further include a network interface device 508 to communicate over a network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a link management component (e.g., the power management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMS, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device;
a data transfer interface comprising a plurality of channels; and
a processing device coupled to the memory device via the data transfer interface, the processing device to perform operations comprising:
monitoring power consumption of the memory device; and
dynamically adjusting a data transfer speed of at least one channel of the plurality of channels of the data transfer interface based on the monitored power consumption of the memory device and a power budget allocated to the memory device, the power budget comprising an amount of power consumption allowed for the memory device.

2. The memory sub-system of claim 1, wherein dynamically adjusting the data transfer speed of the at least one channel comprises decreasing the data transfer speed of the at least one channel based on determining the power consumption of the memory device is above the power budget.

3. The memory sub-system of claim 1, wherein dynamically adjusting the data transfer speed of the at least one channel comprises increasing the data transfer speed of the at least one channel based on determining the monitored power consumption of the memory device is below the power budget.

4. The memory sub-system of claim 1, wherein the operations comprise performing a comparison based on the monitored power consumption of the memory device and the power budget, wherein the dynamic adjusting of the data transfer speed of the at least one channel is based on the comparison.

5. The memory sub-system of claim 4, wherein:
the monitored power consumption of the memory device comprises an amount of power consumed by a die from among multiple dies of the memory device;
the performing of the comparison comprises comparing the amount of power consumed by the die with a portion of the power budget allocated to the die; and
the dynamic adjusting of the data transfer speed of at least one channel comprises adjusting a data transfer speed of a channel of the data transfer interface used by the die.

6. The memory sub-system of claim 5, wherein the adjusting of the data transfer speed of the channel of the data transfer interface comprises one of:
increasing the data transfer speed of the channel based on determining that the amount of power consumed by the die is less than the portion of the power budget allocated to the die; and
decreasing the data transfer speed of the channel based on determining that the amount of power consumed by the die is greater than the portion of the power budget allocated to the die.

7. The memory sub-system of claim 1, wherein dynamically adjusting the data transfer speed of the at least one channel is performed during a data transfer over the data transfer interface based on one of: a read command, a write command, or an erase command.

8. The memory sub-system of claim 1, wherein dynamically adjusting the data transfer speed of the at least one channel comprises accessing a look-up table comprising a mapping between data transfer speeds and power consumption levels.

9. The memory sub-system of claim 8, wherein:
the memory device comprises a plurality of dies;
the monitoring of power consumption of the memory device comprises determining an amount of power consumption for a first die in the plurality of dies;
the operations comprise:
dividing a power budget into a plurality of power tokens, each power token corresponding to a portion of the power budget;
allocating the plurality of power tokens to the plurality of dies, the allocating of the plurality of power tokens comprising allocating a first power token to the first die, the first power token corresponding to a first portion of the power budget; and
comparing the amount of power consumption for the first die with the first portion of the power budget corresponding to the first power token; and
the dynamically adjusting of the data transfer speed of at least one channel comprises adjusting a data transfer speed of a first channel of the data transfer interface used by the first die based on a result of comparing the amount of power consumed by the first die with the first portion of the power budget corresponding to the first power token.

10. The memory sub-system of claim 9, wherein the operations comprise reallocating the plurality of power tokens to the plurality of dies based on the power consumption of the memory device, the dynamically adjusting of the data transfer speed of at least one channel adjusting the data transfer speed of the first channel based on the reallocating of the plurality of power tokens to the plurality of dies.

11. The memory sub-system of claim 10, wherein reallocating the plurality of power tokens to the plurality of dies comprises at least one of:
reallocating the first power token from the first die to a second die; and
reallocating a second power token from a third die to the first die.

12. The memory sub-system of claim 1, wherein the monitored power consumption of the memory device comprises an amount of instantaneous power consumption.

13. The memory sub-system of claim 1, wherein:
the memory device comprises NAND memory;
the data transfer interface comprises an Open NAND Flash Interface (ONFI); and
the processing device comprises a memory sub-system controller.

14. A method comprising:
monitoring, by a processing device, power consumption of a memory device, the memory device being communicatively coupled to a memory sub-system controller via a data transfer interface, the data transfer interface comprising a plurality of channels;
performing, by the processing device, a comparison based on the power consumption of the memory device and a power budget allocated to the memory device; and
dynamically adjusting, by the processing device, a data transfer speed of at least one channel of the plurality of channels of the data transfer interface based on the monitored power consumption of the memory device and a power budget, the power budget comprising an amount of power consumption allowed for the memory device.

15. The method of claim 14, wherein:
the monitored power consumption of the memory device comprises an amount of power consumed by a die from among multiple dies of the memory device;
the performing of the comparison comprises comparing the amount of power consumed by the die with a portion of the power budget allocated to the die; and
the dynamic adjusting of the data transfer speed of at least one channel comprises adjusting the data transfer speed of a channel of the data transfer interface used by the die.

16. The method of claim 15, wherein the adjusting of the data transfer speed of the channel of the data transfer interface comprises decreasing the data transfer speed of the channel based on determining that the amount of power consumed by the die is greater than the portion of the power budget allocated to the die.

17. The method of claim 14, wherein dynamically adjusting the data transfer speed of the at least one channel comprises adjusting the data transfer speed of a channel of the data transfer interface during a data transfer over the data transfer interface based on one of: a read command, a write command, or an erase command.

18. The method of claim 14, wherein dynamically adjusting the data transfer speed of the at least one channel comprises accessing a look-up table comprising a mapping between data transfer speeds and power consumption levels.

19. The method of claim 14, wherein:
the memory device comprises NAND memory;
the data transfer interface comprises an Open NAND Flash Interface (ONFI); and
the memory sub-system controller comprises the processing device.

20. A computer-readable storage medium comprising instructions that, when executed by a processing device, configure the processing device to perform operations comprising:
monitoring power consumption of a memory device, the memory device being communicatively coupled to a memory sub-system controller via a data transfer interface, the data transfer interface comprising a plurality of channels;
performing a comparison based on the power consumption of the memory device and a power budget allocated to the memory device; and
dynamically adjusting a data transfer speed of at least one channel of the plurality of channels of the data transfer interface based on the monitored power consumption of the memory device and a power budget, the power budget comprising an amount of power consumption allowed for the memory device.
